(19) United States
(12) Patent Application Publication
(10) Pub. No.: US 2012/0187110 A1
(43) Pub. Date: Jul. 26, 2012

(54) METHOD FOR PRODUCING A PISTON OF AN INTERNAL COMBUSTION ENGINE BY MEANS OF AN INDUCTIVE ENERGY SUPPLY AND LASER BEAM

(75) Inventor: Christian Schaller, Billigheim (DE)

(73) Assignee: KS KOLBENSCHMIDT GMBH, Neckarsulm (DE)

(21) Appl. No.: 13/377,458

(22) PCT Filed: Jun. 10, 2010
(86) PCT No.: PCT/EP2010/003474

§ 371 Date: Feb. 10, 2012

(30) Foreign Application Priority Data
Jun. 10, 2009 (DE) 10 2009 025 064.6

(51) Int. Cl. H05B 6/02

(52) U.S. Cl. 219/602

(57) ABSTRACT

A method for producing a piston of an internal combustion engine, wherein the piston has a combustion bowl including a combustion bowl rim. The combustion bowl rim is hardened by being remelted in a first step by means of an inductive energy supply and, in a further step, by a laser beam. The beam can be deflected during a rotary, progressive motion relative to the piston.

### CROSS REFERENCE TO CO-PENDING APPLICATION

This application is a continuation of co-pending PCT/EP2010/003474 filed Jun. 10, 2010, the contents of which are incorporated herein in its entirety.

### BACKGROUND

The invention relates to a method for producing a piston of an internal combustion engine by means of an inductive energy supply and laser beam.

It is known from DE 10 2007 044 696.0 in order to produce a piston that has a combustion chamber bowl with a combustion chamber bowl rim to harden the combustion chamber bowl rim by remelting the rim in a first step by means of an inductive energy supply and in a second step by means of a laser beam. This remelting of the rim of the combustion chamber bowl results in a more resistant microstructure so that the durability of the piston, and specifically of the combustion chamber bowl rim, is better able to withstand the extreme demands on current internal combustion engines with respect to combustion pressures and combustion temperatures than combustion chamber bowl rims produced by simple casting of the piston.

For reasons of increasing strength requirements and demand for increased longevity of pistons, this method which is already in use is not yet satisfactory enough because the laser beam melts and hardens only an area limited in its size by the form of the laser beam as it travels around the piston, that is to say, the deeper areas of the combustion chamber bowl rim are not melted and retain the microstructure that was established when the piston, more precisely the piston blank, was cast.

It is desirable to further improve a method for producing a piston of an internal combustion engine in which the combustion chamber bowl rim is heated inductively and melted by means of a laser beam.

### SUMMARY

In accordance with the invention, the intention is for the laser beam to be deflected during a rotary progressive motion relative to the piston.

It must be established that either the piston remains at rest and the laser beam performs a rotary progressive motion relative to the piston, that is to say, that the laser beam itself is moved radially along the combustion chamber bowl rim. An alternative is to aim the laser beam at one point and simultaneously to move the piston in a rotary motion relative to the laser beam. It is conceivable with both these variants that the laser beam is aimed directly at the combustion chamber bowl rim from a laser beam source or a plurality of laser beam sources, or to aim the supply of the at least one laser beam indirectly at the combustion chamber bowl rim, for example, by means of a mirror system (also known as a scanner).

When the present method is carried out, the laser beam, either fixed in position and with a rotating piston or, conversely, is aimed at the combustion chamber bowl rim in such a way that the laser beam from one laser beam source or a plurality of laser beam sources is deflected during its rotary progressive motion relative to the piston. This deflection takes place, for example, relative to a piston stroke axis in an area above and below the crown of the combustion chamber bowl rim, relative to its cross section. In this way it is possible, using the present method, to remelt not only a greater surface area but also a greater depth of the combustion chamber bowl rim and, thus, by changing the microstructure, to achieve hardening that is substantially improved compared with the known method. This means that by carrying out the present method a remelt trace is achieved that is wider and deeper than the remelt trace achieved by the known hardening method.

In a further aspect of the present method, provision is made for the laser beam to be aimed discontinuously at single points in the area of the combustion chamber bowl rim to be remelted during the rotary motion. In order to optimize the remelting process (fusing process) and to remelt a larger area (width and depth) of the combustion chamber bowl, or its combustion chamber bowl rim respectively, the laser beam is split into a plurality of laser points or laser spots. This can be achieved, for example, by an appropriate control mechanism turning the laser beam on and off briefly, or the laser spot can be generated by a suitable optical system by aiming the laser beam at one time at the combustion chamber bowl rim and pointing it away from the rim at another time. This interrupted single-point irradiation of the combustion chamber bowl rim using the laser beam can be carried out continuously in one instance during the rotary motion of either the piston or the laser beam source.

In a further aspect of the present method, provision is made for a partial area of the combustion chamber bowl rim to be initially remelted, the piston being moved further in a rotary motion relative to the laser beam (or conversely by moving the laser beam further in a rotary motion and the piston remains stationary), when the next partial area is remelted and the rotary progressive motion is repeated until the entire combustion chamber bowl rim has been melted over its complete radial periphery. As a result, the entire combustion chamber bowl rim is remelted one partial area at a time to optimize the remelting process and to improve its resistance, where the desired width and depth for the remelting process can be adjusted by the deflection of the laser beam, in particular in conjunction with single-point irradiation.

In a further aspect of the present method, provision is made for the intensity of the laser beam either to remain constant or to be changed in the course of the irradiation, particularly for the single-point irradiation. This means that during the deflection of the laser beam, i.e. while it is passing over the combustion chamber bowl rim, the intensity and thus the energy input can remain constant, which results in a consistent remelting process in the radial periphery of the combustion chamber bowl rim. In the event that different degrees of hardness are desirable locally, i.e. in partial areas, the intensity of the laser beam can be changed during its deflection and also with respect to the rotary motion. As a consequence, different degrees of hardness can be achieved in a partial area of the combustion chamber bowl rim.

In order achieve different degrees of hardness in the combustion chamber bowl rim around its radial periphery, consideration can be given to changing the intensity and thus the energy input by adjusting the time the laser beam remains on the area to be remelted and/or through the energy output of the laser source.

The present method offers the overall advantage that firstly the remelted area (in particular its width and depth) of the combustion chamber bowl rim is clearly increased and additionally, if desired, different degrees of hardness for the combustion chamber bowl rim in its peripheral extent can be adjusted. In addition, the deflection of the laser beam over the area of the combustion chamber bowl rim to be remelted, and specifically the discontinuous single-point irradiation of the combustion chamber bowl rim, offers the substantial advantage that sufficient energy is available for remelting the combustion chamber bowl rim to the desired depth and width while, however, simultaneously preventing the irradiated area from melting away and thus changing the combustion chamber bowl rim in its geometric shape after it has been produced by a casting process (or a forging process).

The present method thus offers the advantage that either with the scanner, beam splitting or by using a plurality of lasers with process time remaining the same (for example, one revolution for finishing the piston), a considerably greater remelt volume can be achieved.

### BRIEF DESCRIPTION OF THE DRAWING

Examples are shown in the drawing of how the combustion chamber bowl rim can be irradiated at single points discontinuously in different ways during the deflection of the laser beam, in which:

FIGS. 1-4 are pictorial representations of single-point discontinuous laser beam irradiation patterns on a combustion chamber bowl rim;

FIG. 5 is partial plan view of a piston combustion chamber bowl rim radiated by the present method; and

FIG. 6 is a partial side elevational view of the piston combustion chamber bowl rim shown in FIG. 5, in an operative position with respect to a laser beam and an induction heater.

### DETAILED DESCRIPTION

An example of a piston 10 having a combustion chamber bowl 12 surrounded by a peripheral rim 14 is positioned for relative movement with respect to an induction heater 16 and a laser beam 18 emanating from a source of laser energy, such as a laser 20 coupled to a suitable energy supply.

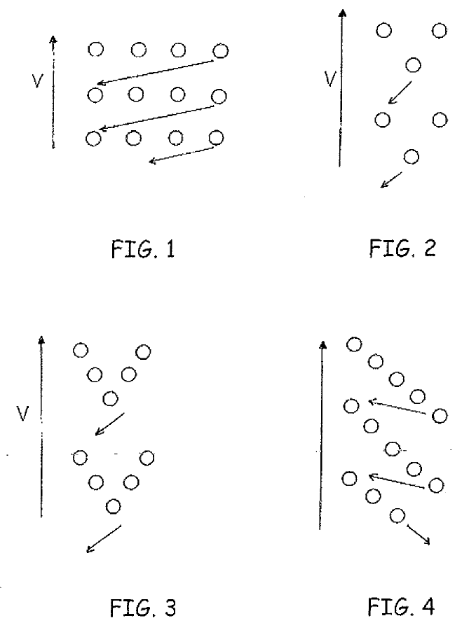

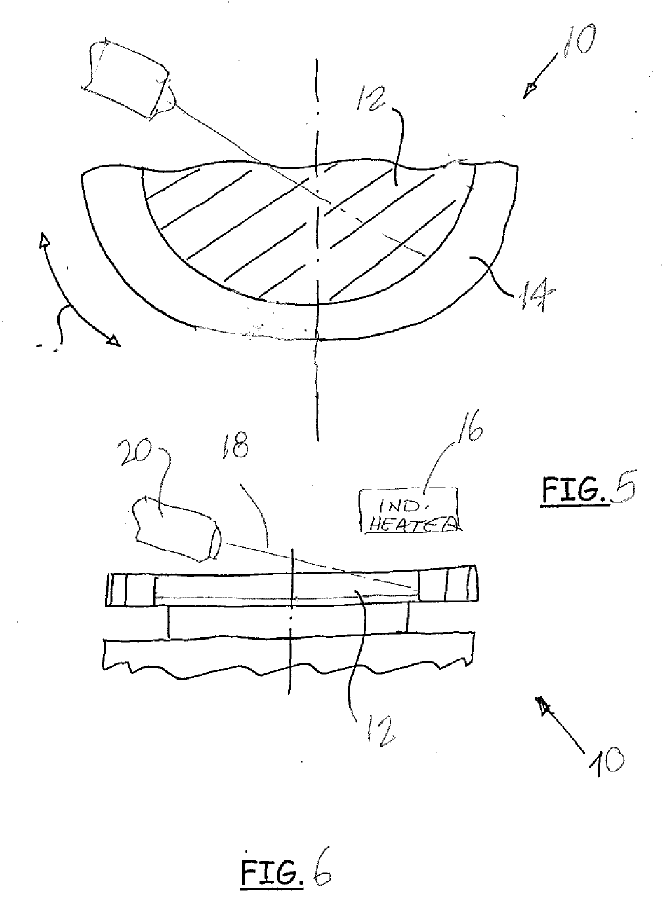

FIG. 1 shows, with reference to the feed direction V of either the piston or of the laser beam during the rotary feed, that initially, referred to the combustion chamber bowl rim passing above and below with reference to a piston stroke axis, several laser spots are irradiated with the laser beam by switching the laser source on and off or by means of a suitable optical system, followed by an advance, the irradiation is repeated, then a progressive motion in the feed direction and again irradiated with the laser beam, which continues until the radial periphery of the combustion chamber bowl rim has been covered once.

The same procedure is shown in FIGS. 2 and 3, where, because of the different number of laser spots, different amount of energy are supplied to remelt the combustion chamber bowl rim.

Finally, FIG. 4 shows a further variation in which the laser beam passes over the area of the combustion chamber bowl rim during the rotary feed motion, where this pass is not necessarily at single points but can be performed continuously.

While FIGS. 1 to 4 show that, based on a single laser spot, the same remelt energy is supplied, consideration can also be given to using different energy levels or dwell times during irradiation.

1. A method for producing a piston of an internal combustion engine, where the piston has a combustion chamber bowl with a combustion chamber bowl rim and the combustion chamber bowl rim is hardened by being remelted in a first step by means of an inductive energy supply and in a further step by means of laser beam, characterized in that the laser beam is deflected relative to the piston during a rotary progressive motion.

2. The method of claim 1, wherein the laser beam is aimed discontinuously at single points at the area of the combustion chamber bowl rim to be remelted.

3. The method of claim 1, wherein initially a partial area of the combustion chamber bowl is remelted, then the piston is moved rotationally further relative to the laser beam, then the next partial area of the combustion chamber bowl rim is remelted, where the rotary progressive motion is carried out in steps until the entire combustion chamber bowl rim has been melted along its radial periphery.

4. The method of claim 1, wherein the intensity of the laser beam remains constant in the course of the irradiation.

5. The method of claim 1, wherein the intensity of the laser beam is changed in the course of the irradiation.

6. The method of claim 5, wherein the change in intensity is adjusted by a dwell time of the laser beam on the area of the combustion chamber bowl rim to be remelted.

7. The method of claim 6, wherein the change in intensity is adjusted by the energy transfer of the laser beam source to the area of the combustion chamber bowl rim to be remelted.

8. The method of claim 1, wherein initially a partial area of the combustion chamber bowl is remelted, then the laser bean is moved rotationally further relative to the piston, then the next partial area of the combustion chamber bowl rim is remelted, where the rotary progressive motion is carried out in steps until the entire combustion chamber bowl rim has been melted along its radial periphery.

9. The method of claim 1, wherein the laser beam outputs single-point irradiation.
